(19) United States
(12) Patent Application Publication
(10) Pub. No.: US 2026/0092687 A1
(43) Pub. Date: Apr. 2, 2026

(54) VEHICLE LAMP

(71) Applicant: SL Corporation, Daegu (KR)

(72) Inventors: Kae Hong KIM, Gyeongsan-si (KR); Hyo Jin HAN, Gyeongsan-si (KR)

(21) Appl. No.: 19/304,568

(22) Filed: Aug. 19, 2025

(30) Foreign Application Priority Data
Sep. 9, 2024 (KR) 10-2024-0122291

(51) Int. Cl. F21S 41/20; F21S 41/30

(52) U.S. Cl. CPC F21S 41/285; F21S 41/30

(57) ABSTRACT

A vehicle lamp includes a plurality of light sources that generate light; a first lens part including a plurality of guiding modules that adjust paths of the light emitted from the plurality of light sources, respectively; and a second lens part through which the light emitted from the first lens part is transmitted to form a predetermined beam pattern. Each of the plurality of guiding modules includes an incident part on which the light emitted from a corresponding light source among the plurality of light sources is incident; an emission part through which the light incident on the incident part is emitted; and a transfer part that guides the light incident on the incident part toward the emission part, and the plurality of light sources are arranged to form at least one row that extends in a left-right direction.

### CROSS-REFERENCE TO RELATED APPLICATION

This application claims priority from Korean Patent Application No. 10-2024-0122291 filed on Sep. 9, 2024, which is incorporated herein by reference in its entirety.

### BACKGROUND

### 1. Technical Field

The present disclosure relates to a vehicle lamp, and more particularly, to a vehicle lamp capable of forming an optimal beam pattern while implementing a slim external design.

### 2. Description of the Related Art

In general, vehicles are equipped with various lamps having an illumination function for more easily identifying objects around the vehicles during low-light conditions (e.g., nighttime driving), and a signaling function for informing other vehicles or pedestrians of the vehicles' driving state.

For example, headlamps and fog lamps are mainly intended for the illumination function, while turn signal lamps, tail lamps, and brake lamps are primarily intended for the signaling function. Each vehicle lamp is regulated by law in terms of installation standards and specifications to ensure that each of these functions can be fully achieved.

In recent years, not only the functional aspect of enabling visibility for drivers, which is the basic role of vehicle lamps and contributes to safe driving, but also the aesthetic aspect perceived by consumers through improvements in exterior design has significantly influenced vehicle purchasing decisions.

To this end, active research is being conducted to allow vehicle lamps to have a slimmer external design while still being capable of forming an optimal beam pattern.

### SUMMARY

One objective of the present disclosure is to provide a vehicle lamp that allows the implementation of a slim external design while improving light efficiency by causing light incident from a plurality of light sources to be reflected by at least one reflective surface and emitted through a plurality of emission parts that form a single row.

The objectives of the present disclosure are not limited to those mentioned above, and other objectives not explicitly stated will be clearly understood by those skilled in the art based on the following description.

According to an aspect of the present disclosure, a vehicle lamp may include a plurality of light sources that generate light; a first lens part including a plurality of guiding modules that adjust paths of the light emitted from the plurality of light sources, respectively; and a second lens part through which the light emitted from the first lens part is transmitted to form a predetermined beam pattern. In particular, each of the plurality of guiding modules may include an incident part on which light emitted from a corresponding light source among the plurality of light sources is incident; an emission part through which the light incident on the incident part is emitted; and a transfer part that guides the light incident on the incident part toward the emission part, and the plurality of light sources may be arranged to form at least one row that extends in a left-right direction.

A central axis of the incident part may be disposed to be spaced apart from a central axis of the emission part in an up-down direction.

The transfer part may include at least one reflective surface that reflects the light incident on the incident part toward the emission part.

The plurality of light sources may be arranged to form a first row and a second row, each of which extends in the left-right direction, the second row may be disposed below the first row, and the plurality of guiding modules may include a first guiding module that adjusts a path of the light emitted from a first light source belonging to the first row; and a second guiding module that adjusts a path of the light emitted from a second light source belonging to the second row. The first and second light sources may be alternately staggered along the left-right direction.

The first guiding module may include a first incident part on which the light emitted from the first light source is incident; a first emission part through which the light incident on the first incident part is emitted; and a first transfer part that guides the light incident on the first incident part toward the first emission part. The second guiding module may include a second incident part on which the light emitted from the second light source is incident; a second emission part through which the light incident on the second incident part is emitted; and a second transfer part that guides the light incident on the second incident part toward the second emission part. Each of the first transfer part and the second transfer part may include a first reflective surface that reflects the light incident through a corresponding incident part in an up-down direction; and a second reflective surface that reflects the light reflected by the first reflective surface in a forward direction.

A central axis of the first incident part may be disposed above a central axis of the first emission part, and a central axis of the second incident part may be disposed below a central axis of the second emission part.

The first reflective surface may be inclined to become closer to a central axis of a corresponding emission part from its rear end toward its front end, and the second reflective surface may be inclined such that it becomes closer to a central axis of the corresponding incident part from its front end toward its rear end.

A front end of the second reflective surface of the first transfer part and a rear end of the second reflective surface of the second transfer part may be configured to determine an upper position of the beam pattern, and a rear end of the second reflective surface of the first transfer part and a front end of the second reflective surface of the second transfer part may be configured to determine a lower position of the beam pattern.

A front end of the second reflective surface of the first transfer part may be disposed farther forward than a front end of the second reflective surface of the second transfer part, and a rear end of the second reflective surface of the second transfer part may be disposed farther rearward than a rear end of the second reflective surface of the first transfer part.

The first reflective surface of each of the first transfer part and the second transfer part may have an inclination angle of about 45 to 60 degrees with respect to a vertical reference line parallel to the up-down direction. The second reflective surface of each of the first transfer part and the second transfer part may have an inclination angle of about 45 to 60 degrees with respect to a horizontal reference line parallel to the front-rear direction.

The emission parts of the plurality of guiding modules may be arranged to form a single row in a direction parallel to the at least one row of the plurality of light sources.

A center line of at least one of the plurality of guiding modules may be tilted at a predetermined angle relative to a center line of at least another of the plurality of guiding modules.

The first lens part may further include an additional reflective part that reflects a portion of the light emitted from the plurality of guiding modules toward the second lens part. The light reflected by the additional reflective part may form an extension region that extends an upper end of the beam pattern.

According to the vehicle lamp of the present disclosure as described above, the following effects may be achieved.

Even if an incident part, through which light from a plurality of light sources is incident, has a relatively large size, it has high light-condensing performance (e.g., light-concentrating power) and, since light is reflected by at least one reflective surface and emitted through a plurality of emission parts that form a single row, light efficiency can be improved while still enabling the realization of a slim external design.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIGS. 1 and 2 are perspective views illustrating a vehicle lamp according to an exemplary embodiment of the present disclosure;

FIG. 3 is a plan view illustrating the vehicle lamp according to an exemplary embodiment of the present disclosure;

FIG. 4 is a cross-sectional view taken along line A-A′ in FIG. 3;

FIG. 5 is a cross-sectional view taken along line B-B′ in FIG. 3;

FIG. 6 is a schematic view illustrating a beam pattern formed by the vehicle lamp according to an exemplary embodiment of the present disclosure;

FIG. 7 is a cross-sectional view illustrating a first guiding module according to an exemplary embodiment of the present disclosure;

FIG. 8 is a cross-sectional view illustrating a second guiding module according to an exemplary embodiment of the present disclosure;

FIG. 9 is a front view illustrating a first lens part according to an exemplary embodiment of the present disclosure;

FIG. 10 is a schematic view illustrating profiles of a first reflective surface and a second reflective surface of a first transfer part and a second transfer part, respectively, according to an exemplary embodiment of the present disclosure;

FIG. 11 is a perspective view illustrating a vehicle lamp according to another exemplary embodiment of the present disclosure;

FIG. 12 is a schematic view illustrating the path of light reflected by an additional reflective part in FIG. 11;

FIG. 13 is a schematic view illustrating an extension region formed by light reflected by the additional reflective part in FIG. 11; and

FIG. 14 is a schematic view illustrating center lines of a plurality of guiding modules according to an exemplary embodiment of the present disclosure.

### DETAILED DESCRIPTION

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Throughout the specification, like reference numerals in the drawings denote like elements.

In some embodiments, well-known steps, structures and techniques will not be described in detail to avoid obscuring the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Embodiments of the disclosure are described herein with reference to plan and cross-section illustrations that are schematic illustrations of exemplary embodiments of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. In the drawings, respective components may be enlarged or reduced in size for convenience of explanation.

The present disclosure will hereinafter be described with reference to the accompanying drawings for explaining a vehicle lamp according to some embodiments of the present disclosure.

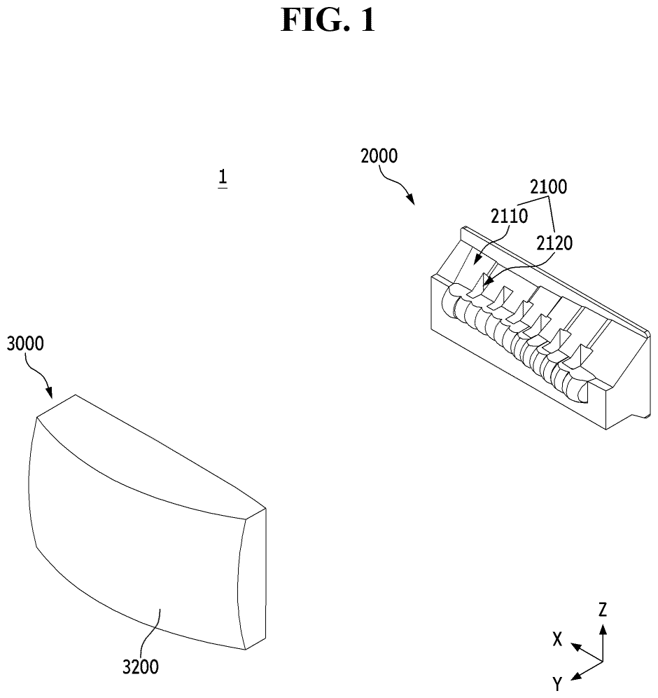

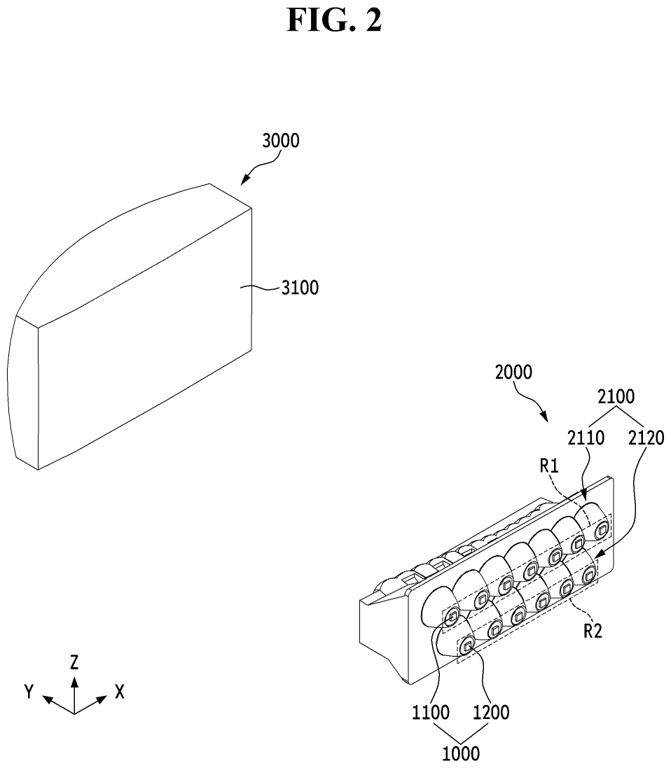

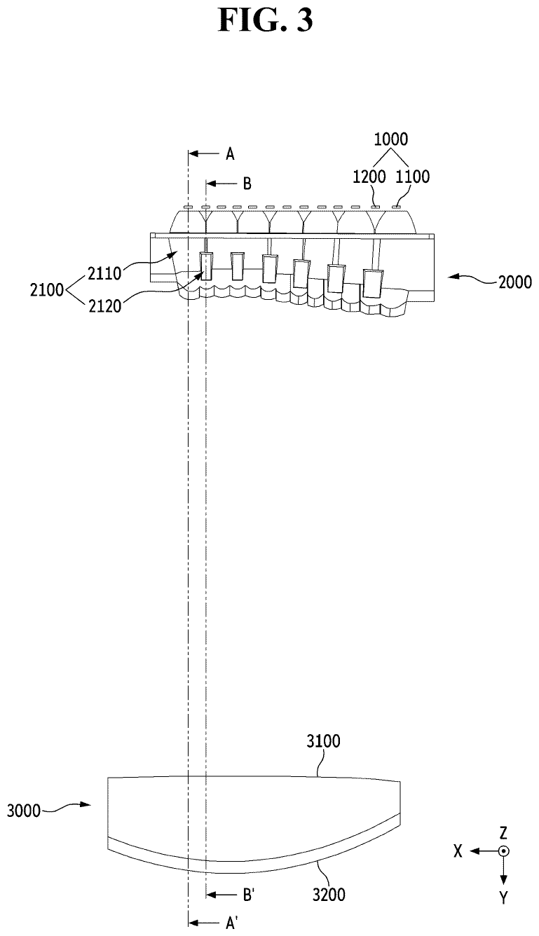

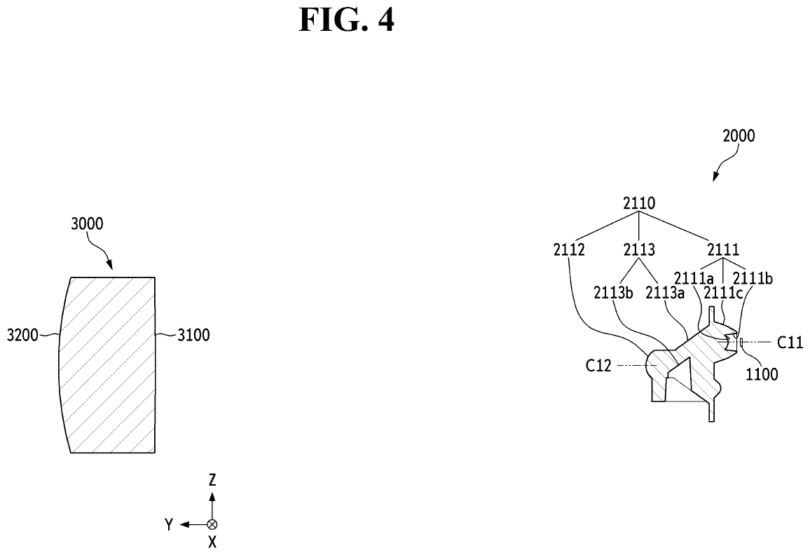

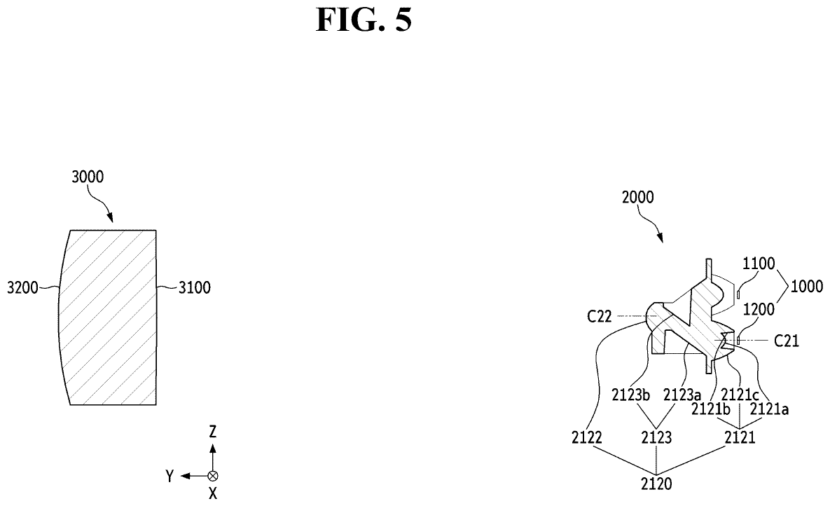

FIGS. 1 and 2 are perspective views illustrating a vehicle lamp according to an embodiment of the present disclosure, FIG. 3 is a plan view illustrating the vehicle lamp according to an embodiment of the present disclosure, FIG. 4 is a cross-sectional view taken along line A-A′ in FIG. 3, and FIG. 5 is a cross-sectional view taken along line B-B′ in FIG. 3.

Referring to FIGS. 1 through 5, a vehicle lamp 1 may include a plurality of light sources 1000, a first lens part 2000, and a second lens part 3000. The X-axis represents a left-right direction, which corresponds to the width or lateral direction of a vehicle, the Y-axis represents a front-rear direction, which corresponds to the traveling or longitudinal direction of the vehicle, and the Z-axis represents an up-down direction, which corresponds to the height or vertical direction of the vehicle. However, the present disclosure is not limited to this, and the actual meanings of the X-, Y-, and Z-axes may vary depending on the installation direction or position of the vehicle lamp 1.

In this embodiment, the vehicle lamp 1 is described, by way of example, as being a headlamp that irradiates light in the driving direction of the vehicle during nighttime or when driving in dark areas such as tunnels, so as to secure the driver's forward field of view, but the present disclosure is not limited thereto. The vehicle lamp 1 may be used not only as a headlamp, but also as various other lamps installed in a vehicle, such as a tail lamp, brake lamp, daytime running lamp, turn signal lamp, fog lamp, backup lamp, and position lamp, and may be used for any one or more of the aforementioned purposes.

When the vehicle lamp 1 is used as a headlamp, it may form at least one of a low beam pattern or a high beam pattern. In the low beam pattern, light may be irradiated below a predetermined cutoff line to secure a wide field of view for the near front of the vehicle without causing glare to drivers of preceding or oncoming vehicles, and in the high beam pattern, at least a portion thereof may be disposed above the cutoff line to secure a long viewing distance for the far front of the vehicle.

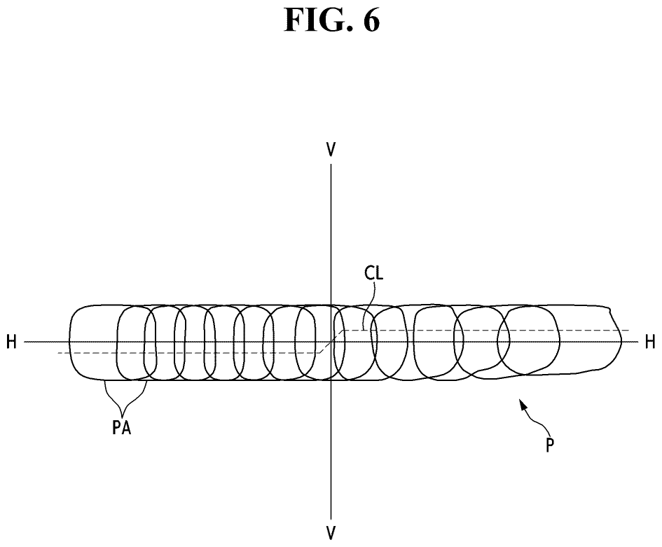

In this embodiment, referring to FIG. 6, a case is described in which the vehicle lamp 1 forms a high beam pattern P, at least a portion of which is disposed above a cutoff line CL, and the high beam pattern P is described, by way of example, as being a beam pattern formed by light irradiated onto a screen positioned at a predetermined distance in front of the vehicle.

The high beam pattern P may include a plurality of pattern regions PA formed by light emitted from the plurality of light sources 1000, respectively. According to the position of a preceding vehicle, at least one of the plurality of light sources 1000 may be turned off to form a shadow area so as to prevent glare to the driver of the preceding vehicle.

The plurality of light sources 1000 may be mounted on a single common substrate and arranged to form at least one row (e.g., R1 or R2) that extends in the left-right direction. In this embodiment, a first row R1 and a second row R2, which is disposed below the first row R1, are described, by way of example, as being formed by the plurality of light sources 1000.

Here, the plurality of light sources 1000 may be implemented as semiconductor light-emitting elements such as light-emitting diodes (LEDs), but the present disclosure is not limited thereto. The plurality of light sources 1000 may also be various types of light sources such as bulbs or laser diodes (LDs), and additional optical elements may be used to adjust the light path, brightness, or color depending on the type of the plurality of light sources 1000.

In this embodiment, for ease of understanding, two rows, i.e., the first and second rows R1 and R2, are described, by way of example, as being formed by the plurality of light sources 1000, but the present disclosure is not limited thereto. Depending on the layout or design of the vehicle lamp 1, the plurality of light sources 1000 may be arranged to form one row or three or more rows.

Among the plurality of light sources 1000, light sources 1100 belonging to the first row R1 and light sources 1200 belonging to the second row R2 may be alternately staggered along the left-right direction. This arrangement is to enable the formation of the plurality of pattern regions PA in a staggered manner, as illustrated in FIG. 6.

In this embodiment, the light sources 1100 belonging to the first row R1 are collectively referred to as “first light sources,” and the light sources 1200 belonging to the second row R2 are collectively referred to as “second light sources.”

The first lens part 2000 may be disposed in front of the plurality of light sources 1000 and serve to adjust the path of light so that the light emitted from the plurality of light sources 1000 travels toward the second lens part 3000, disposed in front of the first lens part 2000.

In this embodiment, the first lens part 2000 is described, by way of example, as being disposed in front of the plurality of light sources 1000, and the second lens part 3000 is described, by way of example, as being disposed in front of the first lens part 2000. However, this is merely exemplary based on the assumption that the direction in which the light is emitted from the vehicle lamp 1 is forward. However, the actual meaning of “forward” or “forward direction”may vary depending on the installation position and/or direction of the vehicle lamp 1.

The first lens part 2000 may include a plurality of guiding modules 2100 that adjust the path of the light emitted from the plurality of light sources 1000, respectively.

In this embodiment, the first light sources 1100 and the second light sources 1200 are described, by way of example, as being alternately staggered along the left-right direction. Accordingly, guiding modules 2110 corresponding to the first light sources 1100 and guiding modules 2120 corresponding to the second light sources 1200 may also be alternately arranged. The guiding modules 2110 corresponding to the first light sources 1100 will hereinafter be referred to as “first guiding modules,” and the guiding modules 2120 corresponding to the second light sources 1200 will hereinafter be referred to as “second guiding modules.”

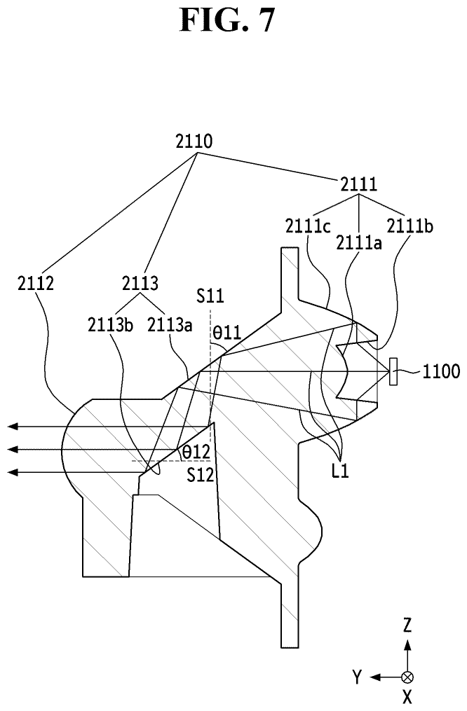

Referring to FIGS. 4 and 7, each of the first guiding modules 2110 may include a first incident part 2111, a first emission part 2112, and a first transfer part 2113. The first incident part 2111 may include a central surface 2111a centered on the optical axis of a corresponding first light source 1100, a protruding surface 2111b formed to protrude toward the corresponding first light source 1100 from the central surface 2111a, and a reflective surface 2111c that reflects the light incident on the protruding surface 2111b forward. The first emission part 2112 may emit the light incident through the first incident part 2111 and transferred via the first transfer part 2113, and may have a convex shape in the forward direction to condense the emitted light.

In this embodiment, a central axis C11 of the first incident part 2111 and a central axis C12 of the first emission part 2112 may be parallel in the front-rear direction, and the central axis C11 of the first incident part 2111 may be offset in an upward direction from a central axis C12 of the first emission part 2112. This is to enable improved light efficiency and implementation of a slim external design. A detailed explanation will be provided later.

The first transfer part 2113 may include a first reflective surface 2113a that reflects the light incident through the first incident part 2111 in the up-down direction (e.g., downward), and a second reflective surface 2113b that reflects the light reflected by the first reflective surface 2113a forward toward the first emission part 2112. The first reflective surface 2113a may be inclined in a front-downward direction toward the central axis C12 of the first emission part 2112, going from its rear end toward its front end. Similarly, the second reflective surface 2113b may be inclined in a rear-upward direction toward the central axis C11 of the first incident part 2111, going from its front end toward its rear end.

In addition, the second reflective surface 2113b may be disposed closer to the first emission part 2112 than the first reflective surface 2113a, so that the light reflected by the first reflective surface 2113a is further reflected toward the first emission part 2112.

Referring to FIG. 7, the first reflective surface 2113a may be formed to have an inclination angle θ11 of about 45 to 60 degrees with respect to a vertical reference line S11, and the second reflective surface 2113b may be formed to have an inclination angle θ12 of 45 to 60 degrees with respect to a horizontal reference line S12. By way of example, the inclination angles θ11 and θ12 of the first and second reflective surfaces 2113a and 2113b may each be greater than 45 degrees.

Specifically, the light traveling in parallel may still be able to be totally reflected by the first and second reflective surfaces 2113a and 2113b with an inclination angle of exactly 45 degrees. Conversely, when light L1 incident through the first incident part 2111 travels to be condensed toward a focus disposed in front of the first incident part 2111, as illustrated in FIG. 7, the inclination angles θ11 and θ12 of the first and second reflective surfaces 2113a and 2113b may be formed to be greater than 45 degrees to allow total internal reflection of the light L1.

In other words, since the first and second reflective surfaces 2113a and 2113b are configured to reflect light via total internal reflection, they need to be formed such that the light incident upon the first incident part 2111 satisfies or exceeds a critical angle for total internal reflection. When the incident light travels to be condensed at the focus in front of the first incident part 2111, the inclination angles θ11 and θ12 of the first and second reflective surfaces 2113a and 2113b may be formed to be greater than 45 degrees in order to ensure total internal reflection of the light incident upon the first and second reflective surfaces 2113a and 2113b.

Furthermore, when the inclination angles θ11 and θ12 of the first and second reflective surfaces 2113a and 2113b exceed 60 degrees, the amount of light reflected by the first and second reflective surfaces 2113a and 2113b may be reduced, thereby degrading light efficiency. Accordingly, the inclination angles θ11 and θ12 of the first and second reflective surfaces 2113a and 2113b may be formed to be no greater than 60 degrees.

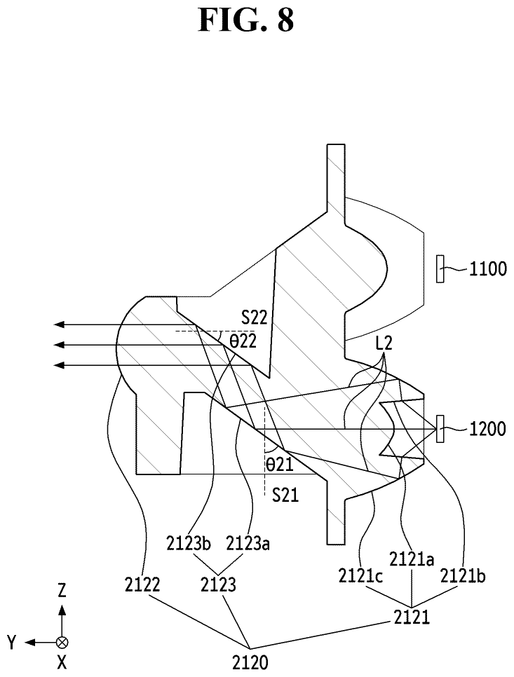

Referring to FIGS. 5 and 8, each of the second guiding modules 2120 may include a second incident part 2121, a second emission part 2122, and a second transfer part 2123. The second incident part 2121, similar to the first incident part 2111, may include a central surface 2121a centered on an optical axis of a corresponding second light source 1200 as a central axis C21, a protruding surface 2121b formed to protrude toward the second light source 1200 from the central surface 2121a, and a reflective surface 2121c that reflects the light incident on the protruding surface 2121b forward. The second emission part 2122 may emit the light that is incident through the second incident part 2121 and transferred via the second transfer part 2123, and may have a convex shape in the forward direction to condense the emitted light.

In this embodiment, the central axis C21 of the second incident part 2121 may be disposed lower than a central axis C22 of the second emission part 2122. This is to improve light efficiency while also enabling the implementation of a slim external design, and a detailed explanation thereof will be provided later.

The second transfer part 2123 may include a first reflective surface 2123a that reflects the light incident through the second incident part 2121 in the up-down direction (e.g., upward), and a second reflective surface 2123b that reflects the light reflected by the first reflective surface 2123a forward toward the second emission part 2122. The first reflective surface 2123a may be inclined in a front-upward direction toward the central axis C22 of the second emission part 2122, going from its rear end toward its front end, and similarly, the second reflective surface 2123b may be inclined in a rear-downward direction toward the central axis C21 of the second incident part 2121, going from its front end toward its rear end.

Additionally, the second reflective surface 2123b may be disposed closer to the second emission part 2122 than the first reflective surface 2123a, so that the light reflected by the first reflective surface 2123a is reflected toward the second emission part 2122.

Referring to FIG. 8, the second transfer part 2123 may also allow light L2 incident through the second incident part 2121 and traveling toward a focus disposed in front of the second incident part 2121 to be totally reflected. Accordingly, the first reflective surface 2123a may be formed to have an inclination angle θ21 of about 45 to 60 degrees with respect to a vertical reference line S21, and the second reflective surface 2123b may be formed to have an inclination angle θ22 of 45 to 60 degrees with respect to a horizontal reference line S22. By way of example, the inclination angles θ21 and θ22 of the first and second reflective surfaces 2123a and 2123b may each be greater than 45 degrees.

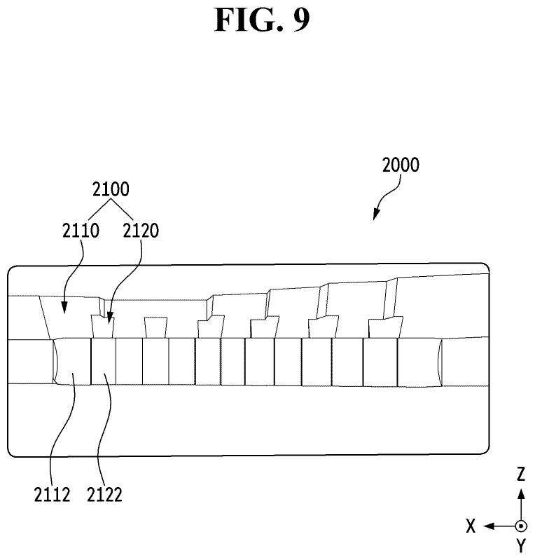

Referring to FIG. 9, the first guiding modules 2110 and the second guiding modules 2120 may be arranged such that the first emission parts 2112 and the second emission parts 2122 form a single row in the left-right direction, which is the direction in which the plurality of light sources 1000 are arranged. As a result, the light emitted from the first light sources 1100 and second light sources 1200 belonging to the first and second rows R1 and R2, respectively, may be emitted through the first emission parts 2112 and second emission parts 2122 that form substantially a single row. This configuration allows the implementation of a slim external design, and due to the high light condensing performance of the first incident parts 2111 and second incident parts 2121 having a total internal reflection (TIR) structure, light efficiency may be improved.

In other words, the TIR structure typically has high light condensing power but a relatively large size. However, in this embodiment, the light incident through the first incident parts 2111 and the second incident parts 2121 may be reflected by the first reflective surfaces (2113a and 2123a) and the second reflective surfaces (2113b and 2123b), respectively, and emitted through the first emission parts 2112 and the second emission parts 2122 that form a single row. As a result, not only may light efficiency be improved due to the high light condensing performance, but a slim external design may also be implemented.

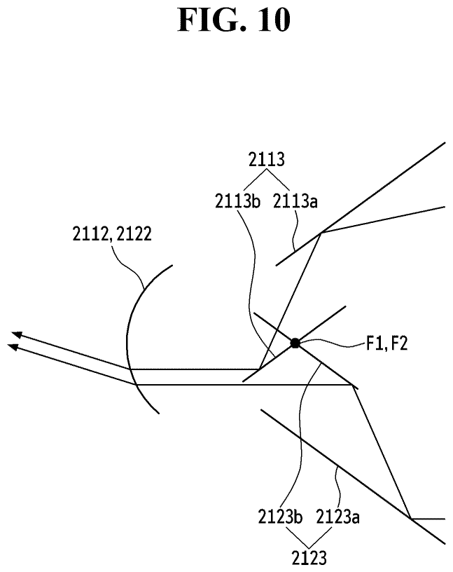

Furthermore, referring to FIG. 10, front ends of the second reflective surfaces 2113b of the first guiding modules 2110 may be disposed farther in the forward direction than front ends of the second reflective surfaces 2123b of the second guiding modules 2120. Rear ends of the second reflective surfaces 2123b of the second guiding modules 2120 may be disposed farther in the rearward direction than rear ends of the second reflective surfaces 2113b of the first guiding modules 2110. This configuration is to enable the upper boundary line of the high beam pattern P in FIG. 6 to be formed higher, thereby improving the viewing distance.

In other words, the front ends of the second reflective surfaces 2113b of the first guiding modules 2110 and the rear ends of the second reflective surfaces 2123b of the second guiding modules 2120 may determine the upper position of the high beam pattern P of FIG. 6, while the rear ends of the second reflective surfaces 2113b of the first guiding modules 2110 and the front ends of the second reflective surfaces 2123b of the second guiding modules 2120 may determine the lower position of the high beam pattern P, as shown in FIG. 10. Therefore, by forming the front ends of the second reflective surfaces 2113b of the first guiding modules 2110 and the rear ends of the second reflective surfaces 2123b of the second guiding modules 2120 to be longer, the upper position of the high beam pattern P may be moved upward.

In other words, referring to FIG. 10, the light reflected forward by regions disposed below a rear-side focus F1 of the first emission parts 2112 of the second reflective surfaces 2113b of the first guiding modules 2110 and a rear-side focus F2 of the second emission parts 2122 of the second guiding modules 2120 may be refracted upward when emitted from the first emission parts 2112 and the second emission parts 2122 to form the high beam pattern P. In this case, the larger the regions disposed below the rear-side foci F1 and F2 of the first emission parts 2112 and second emission parts 2122, the higher the upper boundary line of the high beam pattern P may be formed. Therefore, the front ends of the second reflective surfaces 2113b of the first guiding module 2110 may be formed farther forward than the front ends of the second reflective surfaces 2123b of the second guiding modules 2120, and the rear ends of the second reflective surfaces 2123b of the second guiding modules 2120 may be formed farther rearward than the rear ends of the second reflective surfaces 2113b of the first guiding modules 2110.

The second lens part 3000 may transmit the light emitted from the first lens part 2000 so that the high beam pattern P is formed as illustrated in FIG. 6. In this embodiment, the emission surface 3200 of the second lens part 3000 is described, by way of example, as being more curved than its incident surface 3100 so as to improve light condensing performance, but the present disclosure is not limited thereto. The curvatures of the incident and emission surfaces 3100 and 3200 of the second lens part 3000 may vary depending on the light distribution characteristics of the beam pattern to be formed by the vehicle lamp 1.

Here, to ensure that the light emitted from the first lens part 2000 is incident onto and emitted from the second lens part 3000 with minimal loss, the refractive power of the first lens part 2000 (particularly, the refractive power of the emission parts of the plurality of guiding modules 2100) may be greater than that of the second lens part 3000. As the refractive power of the first lens part 2000 increases, a second lens part 3000 with a relatively slimmer design may be used.

In addition, in this embodiment, part of at least one of the incident surface 3100 or the emission surface 3200 of the second lens part 3000 may be formed to have a different curvature from the rest, but the present disclosure is not limited thereto. The curvatures of the incident and emission surfaces 3100 and 3200 of the second lens part 3000 may vary depending on the light distribution characteristics of the beam pattern to be formed by the vehicle lamp 1.

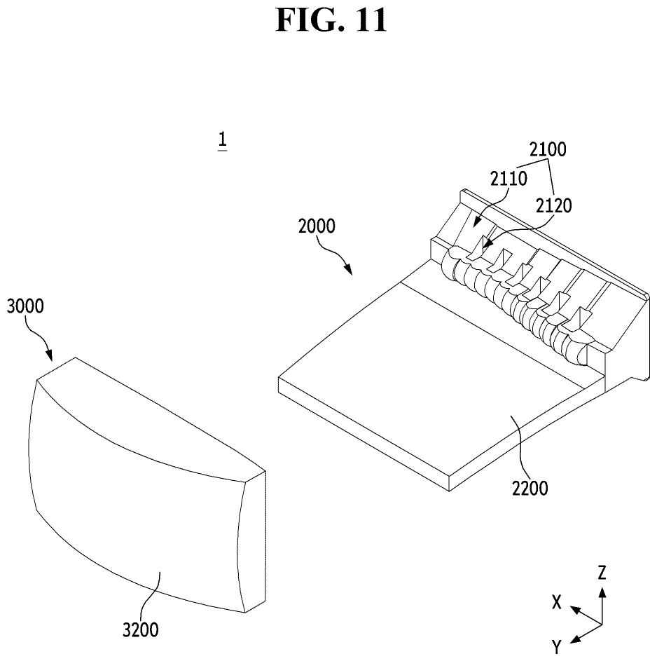

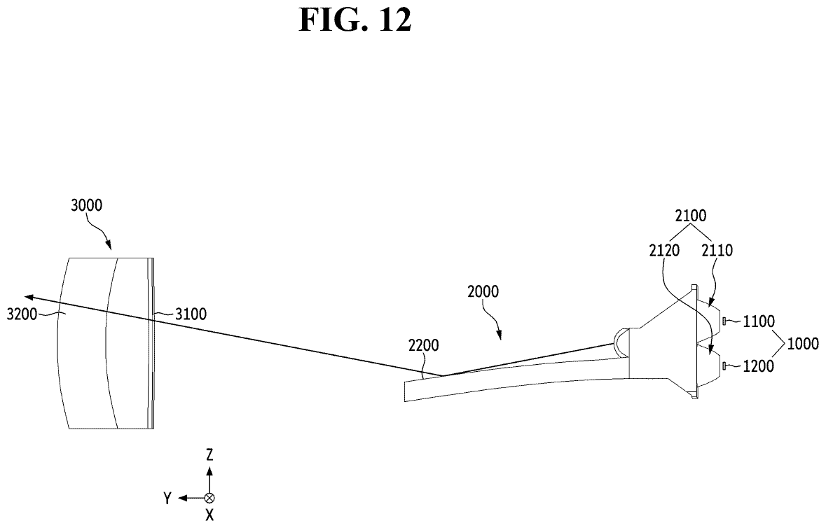

FIG. 11 is a perspective view illustrating a vehicle lamp according to another embodiment of the present disclosure, and FIG. 12 is a schematic view illustrating the path of light reflected by an additional reflective part in FIG. 11.

Referring to FIGS. 11 and 12, a vehicle lamp 1 may include a plurality of light sources 1000, a first lens part 2000, and a second lens part 3000, similar to its counterpart of the previous embodiment. Components having the same functions as their respective counterparts in the previous embodiment are denoted by the same reference numerals, and thus, detailed descriptions thereof will be omitted.

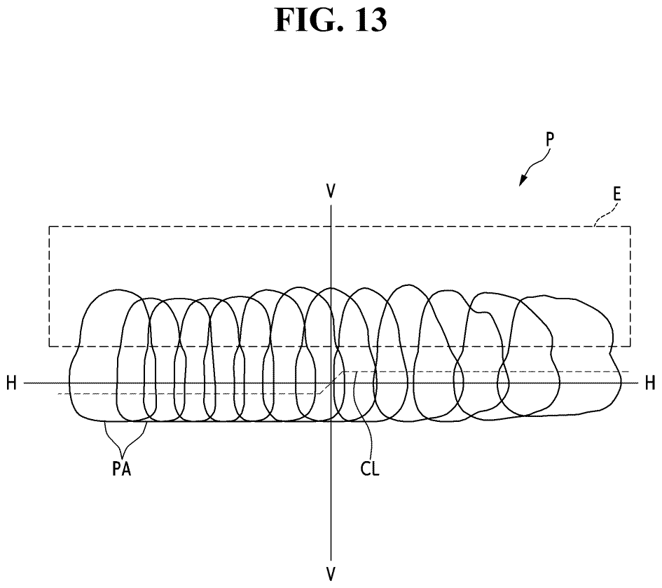

In this embodiment, the first lens part 2000 may further include an additional reflective part 2200 that reflects a portion of the light emitted from a plurality of guiding modules 2100 in a front-upward direction. The additional reflective part 2200 may reflect a portion of the light emitted from first emission parts 2112 and second emission parts 2122 of the guiding modules 2100 in the front-upward direction. Referring to FIG. 13, the light reflected by the additional reflective part 2200 may form an extension region E at an upper end of a high beam pattern P, thereby improving viewing distance.

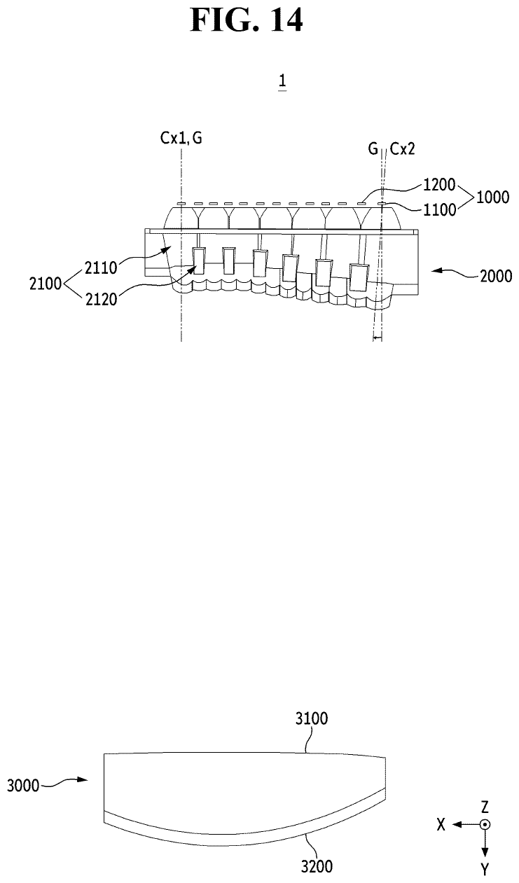

Referring to FIG. 14, at least one of the plurality of guiding modules 2100 may be tilted at a predetermined angle relative to a longitudinal reference line G. In this embodiment, referring to FIG. 14, some guiding modules 2100 disposed on the inboard side (or left side in FIG. 14) of a vehicle may have their center lines Cx1 aligned substantially parallel to the reference line G, and other guiding modules 2100 disposed on the outboard side (or right side in FIG. 14) of the vehicle may have their center lines Cx2 tilted at a predetermined angle toward the inboard side of the vehicle with respect to the reference line G. This configuration may prevent light loss potentially caused by the light emitted from the guiding modules 2100 on the outboard side not being incident onto the second lens part 3000. The guiding modules 2100 having their center lines tilted may vary depending on the size of the second lens part 3000.

Here, the center lines Cx1 or Cx2 of the plurality of guiding modules 2100 may be understood as the lines matching the central axes of the incident parts and emission parts of the plurality of guiding modules 2100.

In FIG. 14, the first lens part 2000 is described, by way of example, as not including the additional reflective part 2200 in FIGS. 11 and 12, but the present disclosure is not limited thereto. This embodiment may also be applied to a case where the first lens part 2000 includes the additional reflective part 2200.

In the foregoing embodiments, since the plurality of light sources 1000 are arranged to form two rows R1 and R2 arranged in an up-down direction, the first light sources 1100 and the second light sources 1200, and the first guiding modules 2110 and the second guiding modules 2120, are described, by way of example, as being alternately staggered in the left-right direction. However, this is merely exemplary for the sake of understanding the present disclosure, and the present disclosure is not limited thereto. In a case where the plurality of light sources 1000 form a single row, the first guiding modules 2110 or the second guiding modules 2120 may be omitted.

In the foregoing embodiments, the light incident through the first incident parts 2111 is described, by way of example, as being totally reflected sequentially by the first reflective surfaces 2113a and second reflective surfaces 2113b of the first transfer parts 2113, and then emitted through the first emission parts 2112. Similarly, the light incident through the second incident parts 2121 is totally reflected sequentially by the first reflective surfaces 2123a and second reflective surfaces 2123b of the second transfer parts 2123, and then emitted through the second emission parts 2122. However, the present disclosure is not limited to this. Alternatively, the light incident through the first incident parts 2111 or the second incident parts 2121 may be reflected by the corresponding first reflective surfaces and second reflective surfaces and transferred to the corresponding emission parts, while the light incident through the other incident parts may be directly transferred to the corresponding emission parts without being reflected.

As described above, the vehicle lamp 1 according to the present disclosure may enable the implementation of a slim external design because the emission parts of the plurality of guiding modules 2100 form a single row while using the incident parts (2111 and 2121) that have relatively high light condensing performance.

In concluding the detailed description, those skilled in the art will appreciate that many variations and modifications can be made to the exemplary embodiments without substantially departing from the principles of the present disclosure. Therefore, the disclosed exemplary embodiments are used in a generic and descriptive sense only and not for purposes of limitation.

What is claimed is:

1. A vehicle lamp comprising:
a plurality of light sources that generate light;
a first lens part including a plurality of guiding modules that adjust paths of the light emitted from the plurality of light sources, respectively; and
a second lens part through which the light emitted from the first lens part is transmitted to form a predetermined beam pattern,
wherein each of the plurality of guiding modules includes:
an incident part on which the light emitted from a corresponding light source among the plurality of light sources is incident;
an emission part through which the light incident on the incident part is emitted; and
a transfer part that guides the light incident on the incident part toward the emission part, and
wherein the plurality of light sources are arranged to form at least one row that extends in a left-right direction.

2. The vehicle lamp of claim 1, wherein a central axis of the incident part is disposed to be spaced apart from a central axis of the emission part in an up-down direction.

3. The vehicle lamp of claim 1, wherein the transfer part includes at least one reflective surface that reflects the light incident on the incident part toward the emission part.

4. The vehicle lamp of claim 1, wherein the plurality of light sources are arranged to form a first row and a second row, each of which extends in the left-right direction,
wherein the second row is disposed below the first row, and
wherein the plurality of guiding modules include:
a first guiding module that adjusts a path of the light emitted from a first light source belonging to the first row; and
a second guiding module that adjusts a path of the light emitted from a second light source belonging to the second row.

5. The vehicle lamp of claim 4, wherein the first and second light sources are alternately staggered along the left-right direction.

6. The vehicle lamp of claim 4, wherein the first guiding module includes:
a first incident part on which the light emitted from the first light source is incident;
a first emission part through which the light incident on the first incident part is emitted; and
a first transfer part that guides the light incident on the first incident part toward the first emission part,
wherein the second guiding module includes:
a second incident part on which the light emitted from the second light source is incident;
a second emission part through which the light incident on the second incident part is emitted; and
a second transfer part that guides the light incident on the second incident part toward the second emission part, and
wherein each of the first transfer part and the second transfer part includes:
a first reflective surface that reflects the light incident through a corresponding incident part in an up-down direction; and
a second reflective surface that reflects the light reflected by the first reflective surface in a forward direction.

7. The vehicle lamp of claim 6, wherein a central axis of the first incident part is disposed above a central axis of the first emission part, and
wherein a central axis of the second incident part is disposed below a central axis of the second emission part.

8. The vehicle lamp of claim 6, wherein the first reflective surface is inclined to become closer to a central axis of a corresponding emission part from a rear end the first reflective surface toward a front end of the first reflective surface, and
wherein the second reflective surface is inclined such that it becomes closer to a central axis of the corresponding incident part from a front end of the second reflective surface toward a rear end of the second reflective surface.

9. The vehicle lamp of claim 6, wherein a front end of the second reflective surface of the first transfer part and a rear end of the second reflective surface of the second transfer part are configured to determine an upper position of the beam pattern, and
wherein a rear end of the second reflective surface of the first transfer part and a front end of the second reflective surface of the second transfer part are configured to determine a lower position of the beam pattern.

10. The vehicle lamp of claim 6, wherein a front end of the second reflective surface of the first transfer part is disposed farther forward than a front end of the second reflective surface of the second transfer part, and
wherein a rear end of the second reflective surface of the second transfer part is disposed farther rearward than a rear end of the second reflective surface of the first transfer part.

11. The vehicle lamp of claim 6, wherein the first reflective surface of each of the first transfer part and the second transfer part has an inclination angle of about 45 to 60 degrees with respect to a vertical reference line.

12. The vehicle lamp of claim 6, wherein the second reflective surface of each of the first transfer part and the second transfer part has an inclination angle of about 45 to 60 degrees with respect to a horizontal reference line.

13. The vehicle lamp of claim 1, wherein the emission parts of the plurality of guiding modules are arranged to form a single row in a direction parallel to the at least one row of the plurality of light sources.

14. The vehicle lamp of claim 1, wherein a center line of at least one of the plurality of guiding modules is tilted at a predetermined angle relative to a center line of at least another of the plurality of guiding modules.

15. The vehicle lamp of claim 1, wherein the first lens part further includes an additional reflective part that reflects a portion of the light emitted from the plurality of guiding modules toward the second lens part.

16. The vehicle lamp of claim 15, wherein the light reflected by the additional reflective part forms an extension region that extends an upper end of the beam pattern.
